(19) United States
(12) Patent Application Publication
(10) Pub. No.: US 2011/0108754 A1
(43) Pub. Date: May 12, 2011

(54) THIXOTROPIC ORGANIC ELECTROLYTE COMPOSITION FOR SUPERCAPACITOR AND PREPARATION METHOD THEREOF

(75) Inventors: Byoung Kyu Kim, Seoul (KR); Byung Jun Lee, Seoul (KR); Sung chul Yang, Seoul (KR)

(73) Assignee: AMOGREENTECH CO., LTD., Kimpo-si (KR)

(21) Appl. No.: 13/003,118

(22) PCT Filed: Jul. 7, 2009
(86) PCT No.: PCT/KR2009/003702

§ 371 Date: Jan. 7, 2011

(30) Foreign Application Priority Data
Jul. 8, 2008 (KR) 10-2008-0066167

(51) Int. Cl. H01G 9/022

(52) U.S. Cl. 252/62.2

(57) ABSTRACT

The present invention relates to an organic electrolyte composition for supercapacitors and a method for preparation thereof. The invention discloses a thixotropic organic electrolyte composition comprising an organic solvent, a salt, and hydrophilic oxide particles. The thixotropic organic electrolyte composition of this invention is a gel or a solid at normal temperature, by overcoming the disadvantages possessed by existing liquid organic electrolytes, and thereby to realize long service life of supercapacitors as well as to secure safety.

### TECHNICAL FIELD

The present invention relates to an organic electrolyte composition for supercapacitors and a method for preparation thereof, and more particularly, to a thixotropic organic electrolyte composition for supercapacitors which has a thixotropic property of being a gel or a solid at normal temperature, and can thereby secure enhancement of the service life characteristics of supercapacitors and safety against overcharging or misuse, and which also has advantages in terms of process such as the flexibility of the design and shape of supercapacitors, and a method for preparation of the composition.

### BACKGROUND ART

Supercapacitors are characterized in that they exhibit a weight energy density of about ½ to 1/10 of secondary batteries depending on the properties of the electrode active material, and the power density, which exhibits the charging-discharging capacity, is about 100 times more excellent.

The electrolytes used in these supercapacitors are roughly classified into aqueous electrolytes and organic electrolytes. Aqueous electrolytes have an advantage of having high ionic conductivity, but the potential range in which the aqueous electrolytes do not undergo an electrochemical oxidation-reduction reaction is narrow, so that there is a limitation on in the production of supercapacitors having higher energy densities. Representative examples of the aqueous electrolytes include sulfuric acid, potassium hydroxide and sodium sulfate that are contained in aqueous solutions.

Organic electrolytes have a disadvantage that the ionic conductivity is lower than the aqueous electrolytes, but have an advantage that the range in which the organic solvent itself does not cause an oxidation-reduction reaction, that is, the organic electrolytes have wide stable potential windows. Therefore, it is advantageous that supercapacitors having high energy densities can be produced. Representative examples of the organic electrolytes include acetonitrile (ACN) containing an alkyl salt, and propylene carbonate (PC).

Among the organic electrolytes, ACN electrolytes containing alkyl salts have lower viscosities than PC electrolytes, and have an advantage of having relatively higher ionic conductivity, so that the ACN electrolytes are more advantageous in the production of supercapacitors having high energy densities and power densities. However, the ACN electrolytes have low boiling points and are thus disadvantageous in terms of safety securement. Therefore, there are limitations in actually applying the ACN electrolytes to supercapacitors.

Therefore, research has been extensively conducted on an organic electrolyte composition, in order to overcome these disadvantages. For example, ethylene carbonate (EC) which has a high boiling point and a high dielectric constant, has a disadvantage that the substance is a solid at normal temperature. In order to complement such a disadvantage, investigations have been conducted on a multicomponent-based electrolyte prepared by mixing ethylene carbonate with a liquid linear carbonate-based organic solvent (dimethyl carbonate, diethyl carbonate, or ethyl methyl carbonate) or a low viscosity ether-based organic solvent such as dimethyl ether (DME) or tetrahydrofuran (THF). These investigations have been carried out to find an electrolyte composition having high ionic conductivity, as well as high viscosity, high boiling point, high electrochemical stability and the like in order to secure safety.

However, the electrolytes that have been hitherto studied still have a fundamental disadvantage that the electrolytes are liquids which undergo volatilization at normal temperature. Liquid electrolytes have an advantage that the ionic conductivity is relatively high as compared with solid-state or gel-state electrolytes. However, liquid electrolytes have flaws in terms of leakage between electrodes, a decrease in the service life characteristics during charging and discharging, and safety securement against overcharging and misuse, and are also disadvantageous in terms of flexibility in the design and shape of supercapacitors.

Therefore, there is still a demand for a new organic electrolyte which can overcome the disadvantages possessed by existing liquid organic electrolytes and is advantageous in producing supercapacitors having long service life and high safety.

### DISCLOSURE OF THE INVENTION

### Problems to be Solved by the Invention

The present invention was made under such technical circumstances, and an object of the invention is to provide, in regard to the production of supercapacitors, a thixotropic organic electrolyte composition which is a gel or a solid at normal temperature, by overcoming the disadvantages possessed by existing liquid organic electrolytes, and thereby to realize long service life of supercapacitors as well as to secure safety.

Despite being a gel or a solid which does not flow unless stirred at normal temperature, the thixotropic organic electrolyte composition of the present invention maintains high ionic conductivity just like liquid electrolytes, and have low volatility so that the organic electrolyte composition greatly contribute to an enhancement of the service life characteristics of supercapacitors, and to safety securement against overcharging and misuse.

### Means for Solving the Problems

In order to achieve the objects, according to the present invention, there is provided a thixotropic organic electrolyte composition for supercapacitors containing an organic solvent, a salt, and hydrophilic oxide particles.

Furthermore, according to the present invention, there is provided a method for producing a thixotropic organic electrolyte composition for supercapacitors, the method including the steps of preparing any one kind of organic solvent selected from ACN, a cyclic carbonate, a linear carbonate and an ether-based organic solvent, or a mixed organic solvent obtained by mixing these; dissolving at least one salt selected from an alkyl-based salt and a lithium-based salt, which are dissolved and dissociated in the organic solvent, in the organic solvent at a concentration in the range of 0.1 to 2 M to obtain an organic electrolyte; and adding hydrophilic oxide particles to the organic electrolyte in an amount of 1% to 30% by weight relative to the total amount of the composition to impart thixotropic properties to the organic electrolyte.

The electrolyte composition for supercapacitors of the present invention is prepared by adding hydrophilic oxide particles to a liquid organic solvent at a certain proportion. Since the added oxide particles have polar hydrophilic chemical groups on the surface, the oxide particles have an action of forming hydrogen bonding with a polar organic solvent, thereby largely reducing fluidity of the liquid organic solvent and converting the liquid state into a gel state or a solid state.

Thixotropy means a property in which a material has consistency in a resting state and is in a gel state or a solid state, but when shaken, the material acquires fluidity. That is, the thixotropic organic electrolyte of the present invention is characterized in that when an external force is applied, for example, when stirred, the organic electrolyte turns into a liquid state and flows, but if not stirred, the organic electrolyte immediately turns into a gel state or a solid state which does not flow. That is, a novel characteristic of the organic electrolyte composition of the present invention is to have thixotropic properties.

As the organic solvent that is used in the preparation of an organic electrolyte in the present invention, any organic compound which has a polar chemical group such as —OH, —COOH, —O—, —CN or —F, is liquid at normal temperature, and has a low viscosity and a high dielectric constant, can be used. For example, acetonitrile (ACN), a cyclic carbonate, a linear carbonate, or an ether-based solvent can be used singly, or a mixed solvent prepared by mixing two or more kinds of these organic solvents at a certain ratio can also be used.

Examples of the cyclic carbonate organic solvent include propylene carbonate (PC), and examples of the linear carbonate organic solvent include dimethyl carbonate, diethyl carbonate, and ethyl methyl carbonate. Examples of the ether-based organic solvent include dimethyl ether (DME) and tetrahydrofuran (THF).

The salt constituting the organic electrolyte of the present invention imparts ionic conductivity to the organic solvent, and at the same time, plays the role of a charge carrier which is accumulated in the electric double layer of an electrode and stores the charge. Thereby, the salt is dissolved in the organic solvent and is dissociated. For the salt constituting the organic electrolyte of the present invention, it is preferable to select one or more from alkyl-based salts and lithium-based salts, but there are no particular limitations on these. Examples of the alkyl-based salts include salts containing alkyl cations that can be dissolved in an organic solvent, such as tetraethylammonium, tetrabutylammonium and tetramethylammonium, as cations, such as tetraethylammonium and tetrafluoroborate (TEABF₄). Examples of the lithium-based salts include LiClO₄, LiPF₆, LiBF₄, LiCF₃SO₃, LiAsF₆, LiN(CF₃SO₂)₂, and LiC(CF₃SO₂)₃.

In the organic electrolyte composition of the present invention, it is appropriate that the salt is added at a concentration in the range of 0.1 to 2 M, and preferably 0.8 to 1.2 M, based on the organic solvent. If the concentration of the salt is too small and is less than 0.1 M, there is a problem that the ionic conductivity of the electrolyte is excessively lowered. If the concentration of the salt exceeds 2 M, there is a problem that the salt is not dissolved in the organic solvent.

For the hydrophilic oxide particles that constitute the organic electrolyte of the present invention, any oxide particles having a polar hydrophilic chemical group such as —OH, —COOH or —CN at the surface can all be used. For example, one or more oxides selected from SiO₂, TiO₂, SnO₂ and FeO₂ are preferred, but there are no particular limitations on these.

The content of the hydrophilic oxide particles used in the preparation of a thixotropic electrolyte in the present invention is in the range of 1% to 30% by weight (hereinafter, the same applies to the percentage), and preferably 2% to 5%, based on the entire organic electrolyte composition. When the hydrophilic oxide particles are added at a content of less than 1%, it is substantially difficult to expect the exhibition of thixotropic properties, and the possibility that the electrolyte may still exist in the liquid state, is high. If the content exceeds 30%, the electrolyte composition completely turns into a solid state, and there occurs a phenomenon in which the ionic conductivity is drastically lowered, which is not preferable.

According to the research results obtained by the inventors of the present invention, the content of the hydrophilic oxide particles may vary with the form of the sample, but it was confirmed that when impregnation or the capillary phenomenon is absent (pouch type), preparation of a thixotropic organic electrolyte can be achieved at a content of up to 30%. If impregnation properties are considered from the aspect of mass productivity (rolled type), it may be difficult to maintain a sufficient gel state when the content of the hydrophilic oxide particles is less than 2%. When the content is greater than 5%, it has been confirmed that the electrolyte composition maintains a gel state but consumes a long time to penetrate into the interior of the element, so that volatilization of the solvent occurs at the initial impregnation area, leaving only the salt and silica behind, and a phenomenon occurs in which the electrolyte composition is partially solidified.

As discussed above, the organic electrolyte composition prepared in the present invention is characterized in that when left to stand at normal temperature, the electrolyte composition immediately retains a gel state or a solid state, but when stirred, the electrolyte composition exhibits a thixotropic phenomenon in which the electrolyte composition turns into a liquid state again or becomes fluid.

These characteristics serve as significant advantages in the process for the production of supercapacitors. That is, in the electrolyte liquid injection stage, the electrolyte composition can be made into liquid by stirring and can be easily injected between electrodes, and when injection has been completed, the electrolyte composition turns into a solid state or a gel state, thereby preventing leakage, contributing to a reduction in the interface resistance between electrodes, and contributing to stabilization. In addition to that, the electrolyte composition allows production of supercapacitors with enhanced service life characteristics and excellent safety.

The organic electrolyte composition prepared in the present invention has an advantage of being applicable to not only electrochemical supercapacitor electrodes which use carbon-based electrodes having large surface areas, or pseudo-supercapacitors involving redox reactions, but also to hybrid supercapacitors using a different material for one electrode of the two electrodes of a supercapacitor.

### Effects of the Invention

Therefore, the thixotropic organic electrolyte composition prepared in the present invention not only allows production of supercapacitors with excellent safety and enhanced service life characteristics, but also has advantages in terms of process, such as flexibility in the design and shape of supercapacitors.

### BEST MODE FOR CARRYING OUT THE INVENTION

Hereinafter, the present invention will be described in more detail by way of preferable Examples.

### Examples

In order to investigate the characteristics of a thixotropic electrolyte composition under the effect of the addition of hydrophilic oxide particles according to the present invention, various kinds of electrolyte compositions were prepared, and then the electric capacitance and service life characteristics were monitored while the scanning rate was varied in the range of 50 to 1000 mV/s by a cyclic voltammetric method. The results are presented in Table 1. Here, the amount of addition of silica (SiO₂) was made uniform at 5% in all cases.

A rayon non-woven fabric was used as a separating membrane, and for the electrodes, an electrode produced by applying an electrode composition containing 85% of activated carbon fibers having a specific surface area of 1,900 m²/g, 5% of vapor grown carbon fiber (VGCF) as an electrically conductive material, and 5% of poly(vinylidene fluoride) (PVdF) as a binder, on a platinum foil specimen having a size of 1 cm×1 cm, in a coating amount of 2.0 mg/cm² was used.

TABLE 1
Characteristics of supercapacitors employing thixotropic
organic electrolyte compositions of present invention

| | | | | | | Initial |
|---|---|---|---|---|---|---|
| | | | | | | capacity |
| | | Stable | | | | retention |
| | | potential | Initial | Energy | Power | (%) @ |
| | | window | capacity | density | density | 10,000 |
| Composition of electrolyte | | (V) | (F/g) | (Wh/kg) | (kW/kg) | times |
| PC/lithium | PC/LiPF₆ (1M) | 3.0 | 92.8 | 116 | 7.0 | 75 |
| salt | SiO₂/PC/LiPF₆ (1M) | 3.1 | 93.1 | 117 | 7.0 | 95 |
| PC/alkyl | PC/TEABF₄ (1M) | 4.1 | 88.0 | 172 | 8.2 | 76 |
| salt | SiO₂/PC/TEABF₄ (1M) | 4.2 | 88.3 | 172 | 8.2 | 95 |
| ACN system | ACN/TEABF₄ (1M) | 3.3 | 123.8 | 181 | 10.0 | 78 |
| | SiO₂/ACN/TEABF₄ (1M) | 3.4 | 124.3 | 182 | 10.0 | 98 |
| EC system | EC/EMC/PC/LiPF₆ | 2.8 | 97.4 | 102 | 6.7 | 73 |
| | (1.1M) | | | | | |
| | SiO₂/EC/EMC/PC/LiPF₆ | 2.9 | 88.5 | 103 | 6.7 | 94 |
| | (1.15M) | | | | | |

PC: Propylene carbonate
ACN: Acetonitrile
EMC: Ethyl Methyl carbonate
EC: Ethylene carbonate

As shown in Table 1, the supercapacitors containing the thixotropic electrolytes of the present invention exhibited, even though being in a gel state induced by their thixotropic properties, almost similar characteristics in terms of the initial capacity, energy density and power density as compared with supercapacitors containing existing liquid organic electrolytes. However, when the thixotropic electrolyte compositions of the present invention added with hydrophilic oxide particles were used, most of the supercapacitors maintained 95% or higher of the initial capacity even after 10,000 times of charging and discharging. Thus, it can be seen that the supercapacitors employing the thixotropic electrolytes of the present invention are far superior in terms of life characteristics.

For example, in the case of a supercapacitor containing a thixotropic electrolyte prepared by incorporating 5% of SiO₂ into propylene carbonate (PC) containing 1 M TEABF₄, it can be seen that while the initial capacity retention of a supercapacitor containing a liquid electrolyte which does not contain SiO2 is 76%, the supercapacitor employing the thixotropic electrolyte of the present invention retains 95% of the initial capacity. It is speculated that such results are shown because when hydrophilic oxide particles, SiO₂, are added, the oxide particles absorb moisture that is present in the electrolyte, and prevent, or minimize, side reactions, thereby maintaining satisfactory reliability.

The present invention has been explained as discussed above by way of Examples, but those having ordinary skill in the art to which the present invention is pertained will understand that these Examples are only for illustrative purposes, and various modifications and equivalent variations can be made. Therefore, the true scope of technical protection of the present invention shall be defined only by the technical idea of the claims attached below.

### INDUSTRIAL APPLICABILITY

The thixotropic organic electrolyte composition of the present invention is applied to supercapacitor electrolytes having high electric capacitance, high energy density, high power and long service life characteristics. For example, the thixotropic organic electrolyte composition is applied to the electrolytes for pseudo capacitors or EDLCs.

1. A thixotropic organic electrolyte composition for supercapacitors, comprising an organic solvent, a salt, and hydrophilic oxide particles.

2. The thixotropic organic electrolyte composition for supercapacitors according to claim 1, wherein the organic solvent is any one selected from acetonitrile (ACN), a cyclic carbonate, a linear carbonate and an ether-based organic solvent, or a mixed organic solvent obtained by mixing these solvents.

3. The thixotropic organic electrolyte composition for supercapacitors according to claim 1, wherein the salt is at least one selected from an alkyl-based salt and a lithium-based salt, which are dissolved and dissociated in the organic solvent.

4. The thixotropic organic electrolyte composition for supercapacitors according to claim 1, wherein the concentration of the salt added to the organic solvent is 0.1 to 2 M.

5. The thixotropic organic electrolyte composition for supercapacitors according to claim 3, wherein the concentration of the salt added to the organic solvent is 0.8 to 1.2 M.

6. The thixotropic organic electrolyte composition for supercapacitors according to claim 3, wherein the alkyl-based salt contains tetraethylammonium, tetrabutylammonium or tetramethylammonium as a cation.

7. The thixotropic organic electrolyte composition for supercapacitors according to claim 3, wherein the lithium-based salt is selected from LiClO₄, LiPF₆, LiBF₄, LiCF₃SO₃, LiAsF₆, LiN(CF₃SO₂)₂, and LiC(CF₃SO₂)₃.

8. The thixotropic organic electrolyte composition for supercapacitors according to claim 1, wherein the hydrophilic oxide particles are formed of at least one selected from SiO₂, TiO₂, SnO₂ and FeO₂.

9. The thixotropic organic electrolyte composition for supercapacitors according to claim 1, wherein the content of the hydrophilic oxide particles is 1% to 30% by weight relative to the total amount of the organic electrolyte composition.

10. The thixotropic organic electrolyte composition for supercapacitors according to claim 1, wherein the content of the hydrophilic oxide particles is 2% to 5% by weight relative to the total amount of the organic electrolyte composition.

11. A method for producing a thixotropic organic electrolyte composition for supercapacitors, the method comprising the steps of:
preparing any one kind of organic solvent selected from ACN, a cyclic carbonate, a linear carbonate and an ether-based organic solvent, or a mixed organic solvent obtained by mixing these;
dissolving at least one salt selected from an alkyl-based salt and a lithium-based salt, which are dissolved and dissociated in the organic solvent, in the organic solvent at a concentration in the range of 0.1 to 2 M to obtain an organic electrolyte; and
adding hydrophilic oxide particles to the organic electrolyte in an amount of 1% to 30% by weight relative to the total amount of the composition to impart thixotropic properties to the organic electrolyte.

12. The method for producing a thixotropic organic electrolyte composition for supercapacitors according to claim 11, wherein the concentration of the salt added to the organic solvent is 0.1 to 2 M.

13. The method for producing a thixotropic organic electrolyte composition for supercapacitors according to claim 11, wherein the content of the hydrophilic oxide particles is 2 to 5% by weight relative to the total amount of the organic electrolyte composition.
